(19) United States
(12) Patent Application Publication
(10) Pub. No.: US 2026/0338135 A1
(43) Pub. Date: Oct. 29, 2026

(54) THRUST REVERSER COMPRISING AN IMPROVED SYSTEM FOR MOVING THE MOVABLE STRUCTURE TOWARDS THE RETRACTED THRUST REVERSAL POSITION THEREOF

(71) Applicant: SAFRAN NACELLES, GONFREVILLE-L'ORCHER (FR)

(72) Inventors: Nicolas Pierre Denis MARIE, MOISSY-CRAMAYEL (FR); Laurent Georges VALLEROY, MOISSY-CRAMAYEL (FR); Vincent Jean-François PEYRON, MOISSY-CRAMAYEL (FR); Pierre Charles CARUEL, MOISSY-CRAMAYEL (FR)

(21) Appl. No.: 19/115,227

(22) PCT Filed: Sep. 29, 2023
(86) PCT No.: PCT/FR2023/051506

§ 371 Date: Mar. 25, 2025

(30) Foreign Application Priority Data
Sep. 29, 2022 (FR) FR2209924

(51) Int. Cl. F02K 1/72; F02K 1/76

(52) U.S. Cl. CPC F02K 1/72; F02K 1/76

(57) ABSTRACT

A thrust reverser comprising a stationary structure and a movable structure comprising at least one movable reverser cowl having a cavity delimited between a radially outer wall and a radially inner wall of the movable reverser cowl, the movable structure being translatable relative to the stationary structure along a longitudinal central axis of the reverser. The reverser also comprises a system for moving the cowl towards the rear, by injecting pressurized air into the cavity, this system including: at least one duct for injecting pressurized air, one end of which communicates with the cavity; a structure for supplying pressurized air to the duct; a controlled valve making it possible, in the open position, for air to flow through the injection duct.

### TECHNICAL FIELD

The invention relates to the field of nacelles and thrust reversers for an aircraft propulsion unit, and, more particularly, to systems making it possible to move the movable structure of such reversers towards the rear.

### PRIOR ART

Thrust reversers are devices making it possible to deflect the air flow through the propulsion unit towards the front, so as to shorten the landing distances and limit the load on the brakes on the landers.

Cascade reversers currently used in the aeronautical sector generally comprise deflection cascades integrated into a stationary structure of the reverser, intended to be connected to a turbine engine casing. A movable structure of the reverser includes one or more movable reverser cowls, and it is mounted translatable relative to the stationary structure between an advanced direct thrust position, and a retracted thrust reversal position. In the advanced direct thrust position, the deflection cascades are arranged in a cavity of the movable reverser cowls, and they are isolated from the secondary flow path of the propulsion unit by a radially inner wall of the reverser cowls. On the other hand, in the retracted thrust reversal position, the radially retracted inner wall of the reverser cowls defines a passage opening from the secondary flow path towards the deflection cascades.

To deflect at least one portion of the secondary flow towards this passage opening in the direction of the cascades, the reverser is also equipped with closing flaps, which, when deployed, close at least partially the secondary flow path. In a known manner, this forces the air from the secondary flow to pass through the passage opening and to join the cascades, which then generate the counter-pressure air flow towards the front. Solutions for closing the secondary flow path using deployable membranes also exist. Such a membrane design is for example known from document FR 3 076 864 A1.

Conventionally, the movement of the movable structure of the reverser, towards the rear in the direction of the retracted thrust reversal position thereof, is carried out using actuators of the hydraulic cylinder or ball screw type actuated by an electric motor, by means of a flexible shaft. This conventional solution is satisfactory, but the presence of actuators as well as the means making it possible to attach them within the reverser are detrimental to the overall mass of the latter.

To respond to this problem, it was proposed to use pressurized air from the secondary flow path to generate pressure on scooping closing flaps, in order to cause the movable structure to move towards the rear. However, this solution is complex to implement, and requires particular kinematics for the closing flaps in order to make them scooping, this kinematics not necessarily being desired by the designer of the reverser.

### DISCLOSURE OF THE INVENTION

In order to at least partially respond to the drawbacks mentioned above and relating to the previous embodiments, firstly the object of the invention is a thrust reverser for an aircraft propulsion unit, the reverser comprising a stationary structure equipped with a radially inner delimiting wall of a secondary flow path of the propulsion unit intended to be passed through by a secondary flow, the reverser also comprising a movable structure comprising at least one movable reverser cowl having a cavity, preferably open towards the front, and delimited between a radially outer wall and a radially inner wall of the movable reverser cowl, the movable structure being translatable relative to the stationary structure along a longitudinal central axis of the reverser, between an advanced direct thrust position and a retracted thrust reversal position.

According to the invention, the reverser also comprises a system for moving the movable cowl to the retracted thrust reversal position, by injecting pressurized air into said cavity, the movable system including:
at least one duct for injecting pressurized air, one end of which communicates with said cavity when the movable cowl is in the advanced direct thrust position, the injection duct being integral with the stationary structure of the reverser;
a means for supplying pressurized air to the injection duct;
a controlled valve making it possible, in the open position, for pressurized air to flow through the injection duct.

The invention thus provides for a system for moving the movable structure based on a simple, reliable, easy to install, and low-mass design. Indeed, it is sufficient here to control the valve so as to make it possible for pressurized air to flow through the injection duct, this air being then injected by the duct into the cavity of the movable cowl in order to generate thereon a pressure causing it to move towards the rear. The proposed movement system, by the design thereof, firstly makes it possible to generate a forward thrust during the beginning of the opening travel of the movable structure, towards the retracted thrust reversal position thereof. The pressure of the air coming from the injection duct may also contribute to moving the movable structure during the continuation of this opening travel, even when the end of the injection duct is no longer in the cavity of the movable cowl, but simply axially facing this cavity. Indeed, during the continuation of this opening travel, other factors and/or means make it possible to ensure the movement towards the rear, such as dragging the air on the outer surface of the movable cowl, negative pressure at the rear thereof, injecting pressurized air coming from the secondary flow path directly into the cavity through the opening generated by the retraction of the cowl, or when the external air enters by scooping into the opening generated at the front of the movable cowl, or the possible presence of an actuator that would then be of a size smaller than those normally encountered. Nevertheless, the invention is preferably implemented without an actuator for the flight opening travel, a smaller actuator may nevertheless be retained for test operations and/or to permit ground maintenance operations with the movable structure in the retracted position.

Furthermore, an actuator may be provided to ensure the closing travel of the movable structure of the reverser, corresponding to the movement thereof from the retracted thrust reversal position, to the advanced direct thrust position.

Finally, the invention does not require the implementation of scooping-type closing flaps, but conversely, the design of the means for closing the secondary flow path remains advantageously free.

The invention preferably provides for at least one of the following optional technical features, taken alone or in combination.

Preferably, the stationary structure includes a deflection edge against which the radially inner wall of the movable reverser cowl is bearing, when it occupies the advanced direct thrust position thereof, and the pressurized air injection duct is supported by the deflection edge, preferably at the rear of the latter.

Preferably, the means for supplying pressurized air to the injection duct includes at least one scoop, designed to scoop pressurized air from the secondary flow into the secondary flow path. Nevertheless, other solutions are still possible, such as the fact of taking air directly from a compressor on the turbine engine.

Preferably, the number of compressed air injection ducts within the movement system is between one and six, distributed circumferentially about the longitudinal central axis. However, this number may differ, without departing from the scope of the invention.

Preferably, in the retracted thrust reversal position of the movable structure, the stationary structure of the reverser and an upstream end of the radially retracted inner wall of the reverser movable cowl reveal between them an air passage opening through the secondary flow path, the thrust reverser also comprising means for closing the secondary flow path, designed to deflect at least one portion of the secondary flow to the passage opening. Preferably, these closing means comprise at least one closing flap and/or at least one closing membrane.

Preferably, the stationary structure of the reverser includes at least one deflection cascade arranged, in the advanced direct thrust position of the movable structure, in the cavity of the movable cowl, by being isolated from the secondary flow path by the radially inner wall of the reverser cowl. Alternatively, the deflection cascade(s) may be integrated into the movable structure of the reverser, without departing from the scope of the invention.

Preferably, the reverser also includes a device for damping the end of opening travel of the movable cowl, in the movement thereof ranging from the advanced direct thrust position to the retracted thrust reversal position. These damping means may be incorporated into additional cylinders for opening or closing the movable cowl.

Preferably, the reverser includes means for taking up the counter-thrust forces between the movable structure and the stationary structure, generated on the means for closing the flow path and the movable structure. These means may be shared with the damping device and/or the additional opening and closing cylinders, or may be separate means such as stops at the slide rails or dedicated telescopic rods.

Another object of the invention is an aircraft propulsion unit, comprising a turbine engine and a nacelle including at least one fan cowling, as well as a thrust reverser as described above.

Another object of the invention is a method for controlling such a thrust reverser. In order to drive the movement of the movable structure from the advanced direct thrust position thereof to the retracted thrust reversal position thereof, the method comprises a step of unlocking the movable cowl relative to the stationary structure of the reverser, as well as a step of controlling the valve of the movement system so as to bring it to the open position, making it possible for pressurized air to flow through the injection duct and to inject this pressurized air into the cavity of the movable cowl, in order to cause it to move to the retracted thrust reverser position thereof.

Other advantages and features of the invention will appear in the non-limiting detailed description below.

### BRIEF DESCRIPTION OF THE DRAWINGS

The following detailed description refers to the appended drawings wherein:

FIG. 1 is a schematic half-view in longitudinal section of a propulsion unit, comprising a thrust reverser according to a preferred embodiment of the invention, shown in a direct thrust configuration;

FIG. 2 is a schematic half-view in longitudinal section of the reverser equipping the propulsion unit shown in FIG. 1, with the reverser shown in direct thrust configuration;

FIG. 3 is a schematic half-view of the reverser shown in FIG. 2, shown in thrust reversal configuration;

FIG. 3A is a schematic half-view similar to that of the previous figure, with the reverser being shown according to an alternative embodiment;

FIG. 4 is a perspective view of the reverser shown in FIGS. 2 and 3, shown in a direct thrust configuration;

FIG. 5 is a perspective view of the reverser shown in FIG. 4, shown in thrust reversal configuration;

FIG. 6 is a schematic half-view in longitudinal section similar to that of FIG. 2, according to another sectional plane showing the system for moving the movable cowl specific to the invention;

FIG. 6A is a schematic half-view in longitudinal section similar to that of FIG. 6, according to another preferred embodiment of the invention;

FIG. 6B is a partial cross-sectional view, showing the reverser according to another preferred embodiment of the invention;

FIG. 7 is a schematic half-sectional view taken along line VII-VII of FIG. 6;

FIG. 8 is a schematic half-view in longitudinal section similar to that of FIG. 6, with the reverser still shown in direct thrust configuration, but just before the beginning of the opening travel of the movable reverser cowls;

FIG. 9 is a schematic half-view in longitudinal section similar to that of FIG. 6, with the reverser shown in thrust reversal configuration;

FIG. 10 is a schematic half-view in longitudinal section similar to that of FIG. 2, with the reverser being in the form of another preferred embodiment of the invention; and

FIG. 11 is a schematic half-view in longitudinal section similar to that of FIG. 10, with the reverser being shown in the form of an alternative embodiment.

### DESCRIPTION OF THE EMBODIMENTS

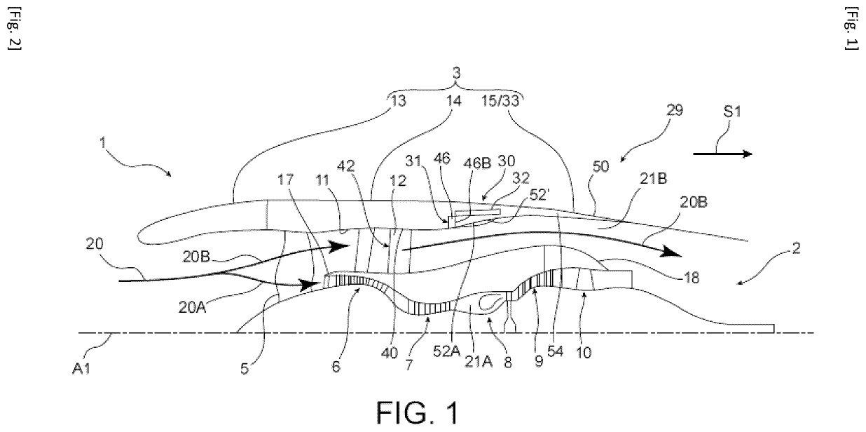

An aircraft propulsion unit 1 is shown in FIG. 1, having a longitudinal central axis A1.

Subsequently, the terms “upstream” and “downstream” are defined relative to a general direction S1 of flow of gasses through the propulsion unit 1, along the axis A1 when it generates a thrust. These terms “upstream” and “downstream” may be substituted by the terms “front” and “rear”, respectively, with the same meaning.

The propulsion unit 1 comprises a turbine engine 2, a nacelle 3 as well as a mast (not shown), intended to connect the propulsion unit 1 to a wing (not shown) of the aircraft.

The turbine engine 2 is in this example a dual-flow, twin-body turbojet engine comprising, from the front towards the rear, a fan 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbojet 2 is equipped with a fan casing 11 connected to the gas generator by structural arms 12.

The nacelle 3 comprises a front section forming an air inlet 13, a middle section that includes two fan cowlings 14 enveloping the fan casing 11, and a rear section 15.

In operation, an air flow 20 enters the propulsion unit 1 through the air inlet 13, passes through the fan 5 then splits into a primary flow 20A and a secondary flow 20B. The primary flow 20A flows into a primary gas circulation flow path 21A passing through the gas generator. The secondary flow 20B flows into a secondary flow path 21B surrounding the gas generator. The secondary flow path 21B is delimited radially inwards by a fixed inner shroud that surrounds the gas generator. In this example, the fixed inner shroud comprises a first section 17 belonging to the middle section 14, and a second section 18 extending towards the rear from the first section 17, so as to form a portion of the rear section 15. This second section 18 is an integral part of a stationary structure of a thrust reverser which will be described below. This same section will subsequently be referred to as the radially inner delimiting wall 18 of the secondary flow path 21B.

Radially outwards, the secondary flow path 21B is delimited by the fan casing 11, and, in the configuration of FIG. 1, by one or more movable reverser cowls 33 forming a portion of the rear section 15 of the nacelle 3, and which will be described later. More precisely, between the fan casing 11 and the reverser cowls 33, an outer ferrule 40 of an intermediate casing 42 is provided, the latter comprising the aforementioned structural arms 12, the radially outer end of which is attached to this ferrule 40. It therefore also contributes to delimiting the secondary flow path 21B radially outwards, by being located in the axial extension downstream of the fan casing 11.

The nacelle 3 therefore includes a thrust reverser 30 centered on the axis A1 and comprising, on the one hand, a stationary structure 31 integral with the fan casing 11, and, on the other hand, a structure 29 movable relative to the stationary structure 31. The stationary structure 31 includes for example a front frame 46 which firmly connects it to the fan casing 11, preferably via a knife-edge assembly located downstream of the outer ferrule 11. This front frame 46 contains a profiled aerodynamic part called the deflection edge 46B, which guides the reverse jet flow.

Here, the stationary structure 31 also includes a plurality of deflection cascades 32 arranged adjacent to one another about the axis A1, in a circumferential direction of the reverser 30 and the propulsion unit 1. Moreover, the movable structure 29 comprises for its part the aforementioned movable reverser cowls 33, for example two cowls 33 each extending over an angular amplitude of about 180°. This two-cowl configuration 33 is particularly well suited in the case of a nacelle design wherein the cowls/walls 18 are also mounted articulated, the reverser 30 then having a so-called “D-Duct” architecture. In this architecture, the cowls 18, 33 are connected so as to open/close simultaneously during maintenance operations on the engine. Nevertheless, other architectures are possible, such as for example a so-called “C-Duct” architecture, or a so-called “O-Duct” architecture.

Each reverser cowl 33 includes a radially outer wall 50 forming an outer aerodynamic surface of the nacelle, as well as a radially inner wall 52 participating in delimiting the secondary flow path 21B radially outwards. This wall 52 is located in the downstream continuity of the outer ferrule 40 of the intermediate casing. The two walls 50, 52 define a cavity 54, preferably open axially towards the front at the upstream end of the reverser cowl 33.

FIG. 1 shows the reverser 30 in a forward thrust configuration, known as “direct jet”, corresponding to a standard flight configuration. In this configuration, the cowls 33 of the movable structure 29 are in a closed position, known as advanced thrust or “direct jet” position, wherein these reverser cowls 33 are bearing on the stationary structure 31, in particular on the deflection edge 46B forming an integral part of the latter. Indeed, in the direct thrust configuration, the upstream end 52a of the radially inner wall 52 of each cowl 33 is axially bearing against the deflection edge 46B.

The retention of the movable cowl 33 in the advanced direct thrust position is ensured by means for locking this cowl on the stationary structure 31 of the reverser. These controlled locking means (not shown) are conventional, therefore they will not be described further.

The movable structure 29 is thus translatable relative to the stationary structure 31 along the axis A1 of the reverser, between the advanced direct thrust position shown in FIG. 1, and a retracted thrust reversal position that will be described later. In the advanced direct thrust position of the movable structure 29, the deflection cascades 32 are arranged in the cavity 54 of the reverser cowls 33, by being isolated from the secondary flow path 21B by the radially inner wall 52 of these reverser sliding cowls 29. This wall 52, forming the outer wall of the secondary flow path, is also called the acoustic inner panel.

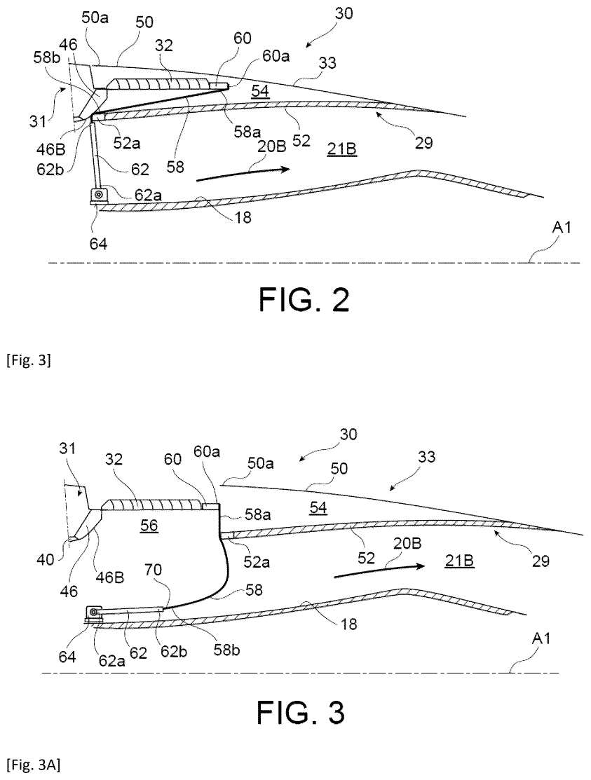

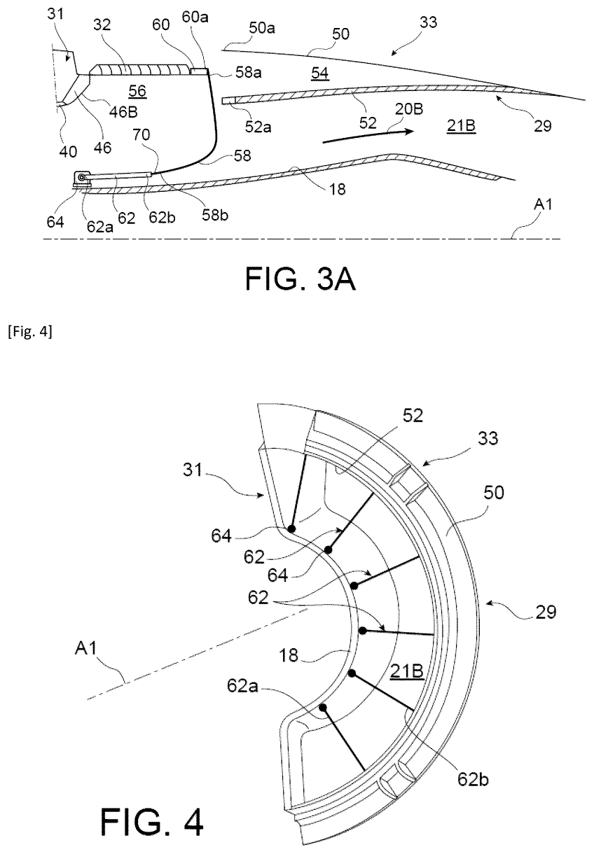

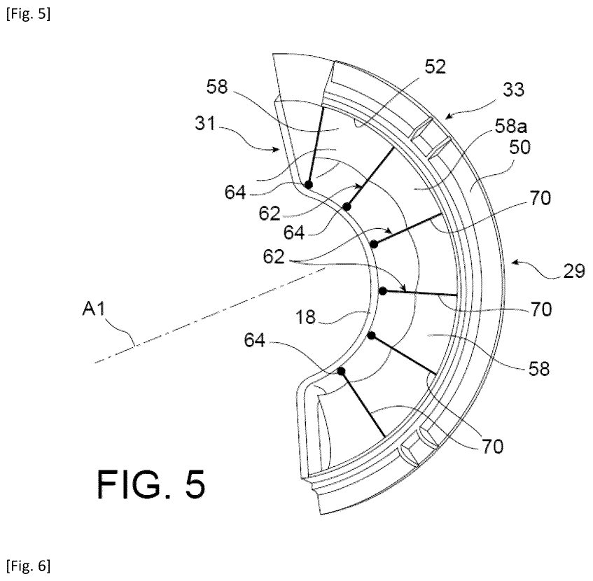

This direct thrust configuration is also shown in FIGS. 2 and 4, whereas the retracted thrust reversal position of the movable structure 29 is shown in FIGS. 3 and 5. In FIG. 3, it is shown that the retracted inner acoustic panel 52 of the reverser cowls reveals upstream a passage opening 56 from the secondary flow path 21B to the deflection cascades 32. The opening 56 is therefore also delimited upstream by the deflection edge 46B, which flares radially outwards going towards the rear, to direct an air flow intended to pass through the cascades 32 when the movable system is in this retracted thrust reversal position. In other words, the deflection edge 46B gradually moves away from the axis A1 going from the front towards the rear, to guide/deflect the air towards the cascades 32 in thrust reversal configuration. Downstream, the passage opening 56 is delimited in particular by the upstream end 52a of the radially inner wall 52.

In order to deflect at least one portion of the secondary flow 20B to the passage opening 56 defined axially between the deflection edge 46B and the upstream end 52a of the radially inner wall 52 of each cowl 33, the reverser 30 includes in this preferred embodiment one or more closing membranes 58. Subsequently, an embodiment will be described wherein a single membrane 58 is associated with each reverser cowl 33 having an identical or similar angular amplitude, but it remains conceivable to provide a plurality of circumferentially adjacent membranes associated with each cowl 33. Similarly, only the cooperation between a membrane 58 and the associated cowl 33 thereof will be described below, it being understood that this cooperation is identical or similar for all the cowls of the reverser 33.

The membrane 58 may be made of a material known to the person skilled in the art for this type of application. For example, it may be an unimpregnated fabric, for example aramid fibers. The membrane 58 may also be produced using a composite material the matrix of which is particularly flexible, for example made of aliphatic polyurethane, which makes it possible to be used under different temperature conditions, in particular lower temperatures in the case of an aliphatic polyurethane membrane than in the case of a silicone membrane. The matrix gives a low capacity to bend back and the behavior of the structure obtained is indeed that of a membrane. One of the major properties of this membrane 58 is to be able to be folded perfectly reversibly (elastically or by sliding fibers) with a very small radius of curvature relative to the surface thereof, and to have a very small thickness, for example in the order of 0.1 to 3 mm. For information purposes, it is observed that this membrane 58 behaves like a boat sail or a parachute/flying wing when it is pressurized.

Still with reference to FIGS. 1 to 5, first attachment means are provided connecting a first end 58a of the closing membrane 58 to a rear frame 60 for supporting the cascades 32, this annular support or annular section-shaped support effectively connecting the rear end of a plurality of adjacent cascades. In addition, second attachment means connect a second end 58b of the closing membrane 58, opposite the first membrane 58a, to the wall 18.

Furthermore, as can be seen in FIGS. 1, 2 and 4, when the movable structure 29 occupies the advanced direct thrust position thereof, at least one portion of the closing membrane 58 is arranged radially between the deflection cascades 32 and the radially inner wall 52 of the reverser cowl 33, in the cavity 54. Preferably, the portion of the membrane 58 that is in this cavity 54 of the reverser cowl 33 radially covers the entire length of the cascades 32. Consequently, when the movable structure 29 adopts the advanced direct thrust position thereof, the second end 58b of the membrane 58 is pinched between the upstream end of the wall 18, and the deflection edge 46B. In order to avoid possible damage to the membrane 58 due to this pinching, the deflection edge 46B may locally have a notch of a shape adapted to receive the upstream end 52a of the wall 52. Thus, the membrane 58 is also pressed into this notch of the deflection edge 46B, by bearing on the upstream end of the wall 52.

In addition, as can be seen in FIG. 3, when the movable structure 29 moves and when it occupies the retracted thrust reversal position thereof at the end of this movement, the closing membrane 58 is partially bearing against the upstream end 52a of the radially inner wall 52 of the reverser cowl, therefore corresponding to the acoustic panel. More precisely, during the movement towards the rear of the movable structure 29, the membrane 58 slides on this upstream end 52a of the radially inner wall 52.

In the retracted thrust reversal position of FIG. 3, the membrane 58 is therefore axially bearing downstream against the upstream end 52a. It should be noted that depending on the extent of the axial travel of the reverser, the membrane 58 may no longer be in contact with the inner acoustic panel 52 in the fully deployed position of the reverser, where the cowl 33 is in the most retracted position thereof. Such a configuration is shown in FIG. 3A, wherein it is shown that the membrane 58 is upstream and away from the upstream end 52a of the wall 52 of the reverser cowl. The contact option corresponds to a minimized travel of the reverser, whereas the non-contact option generally corresponds to a smoother diaphragm shape in reversed jet, therefore performing better from an aerodynamic point of view.

Thus, the portion of the membrane 58 that is located radially outwards relative to the bearing zone thereof on the wall 52 closes off a portion of the axial opening upstream of the cavity 54, whereas the other portion located radially inwards closes off at least one portion of the secondary flow path 21B, thereby deflecting at least one portion of the secondary flow 20B towards the passage opening 56 in the direction of the cascades 32.

Another possibility, not shown, consists in performing the radially external attachment of the membrane 58 to the radially outer wall 50 of the sliding cowl 33. The end 58b of the membrane 58 has for its part cables 70 connected to the wall 18 (also referred to as IFS “Inner Fixed Structure”), by a connection which may advantageously exert a tensile force on each cable 70 returning it to this wall 18, for example by means of an elastic connection. The cables 70 themselves may be elastic, for example by using kevlar cables, and these same cables may be tensioned when the sliding cowl 33 is closed. Reinforcements may be integrated into the membrane 58 in the extension of these cables 70, up to the outer attachment points with the rear cascade support frame 60, or the outer wall 50 of the sliding cowl 33.

These cables 70 are advantageously positioned radially in the flow path by being circumferentially spaced apart from one another. In the direct jet position, they tension the membrane 58 between the end 58a thereof and the leading edge/the upstream end 52a of the wall 52 of the cowl. During deployment, when the sliding cowl 33 retracts, the cables 70 pull the membrane 58 towards the secondary flow path so that it takes air therein and gradually deploys therein.

According to the purpose sought, the second attachment means may consist of connecting rods 62, instead of the cables mentioned above. A first end 62a of each of them is mounted on the wall 18, preferably by means of a pivot or ball joint connection 64. This connection 64 may be produced using a fitting attached to the fixed wall 18 and cooperating with the first connecting rod end 62a.

The connecting rods 62 are circumferentially spaced apart from one another within the secondary flow path 21B, and the number thereof may for example vary from two to ten.

Each connecting rod 62 is designed to move from a protruding position radially in the secondary flow path 21B, position shown in FIGS. 2 and 4 adopted when the movable structure 29 occupies the advanced direct thrust position thereof, to a position folded downwards, shown in FIGS. 3 and 5 adopted when the movable structure 29 occupies the retracted thrust reversal position thereof.

Elastic return means may be provided to tend to tilt each connecting rod 62 towards the folded/lying position thereof of FIG. 3, in particular when the connecting rod is in the protruding position thereof corresponding to the flight position of the reverser.

The second end 62b of each connecting rod 62, opposite the first end 62a, may be connected directly to the second end 58b of the membrane 58. Nevertheless, other preferred solutions are retained, such as those aiming to integrate cables or reinforcement straps within the second attachment means.

In the embodiment shown in FIGS. 1 to 5, the cables 70 cooperate with the connecting rods 62 by each being attached to the second end 62b of one of the connecting rods associated with this cable. Alternatively, the cables 70 may pass through the associated connecting rods 62 thereof to be attached to the radially inner delimiting wall 52 of the secondary flow path, for example via the fittings 66.

It is reminded that in a conventional cascade reverser, the movable structure slides relative to the stationary structure by means of a rail/slide system that guides the movable structure from the front towards the rear during the reverser opening phase, and from the rear towards the front during the closing phase. A force towards the rear applied to the movable structure of the reverser therefore causes the movement thereof towards the rear, relative to the stationary structure. This force is usually generated by conventional actuators such as cylinders or ball screws.

By contrast, one of the particularities of the invention lies in the fact that the reverser is not equipped with conventional actuators making it possible to move the movable structure 29 towards the rear, from the advanced direct thrust position thereof to the retracted thrust reversal position thereof. In other words, unlike conventional designs, there is no provision for a cylinder or ball screws intended to generate and control the entire opening travel of the movable cowls 33 to the retracted thrust reversal position, between the two extreme positions thereof. Consequently, there is also no provision for a motor or pump that would provide the hydraulic, electrical or pneumatic energy to actuate these cylinders or ball screws.

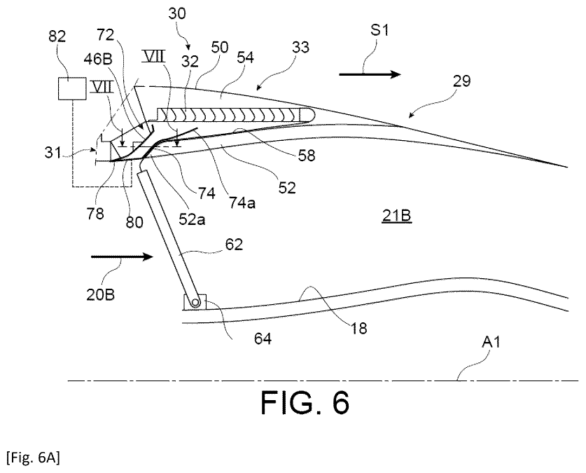

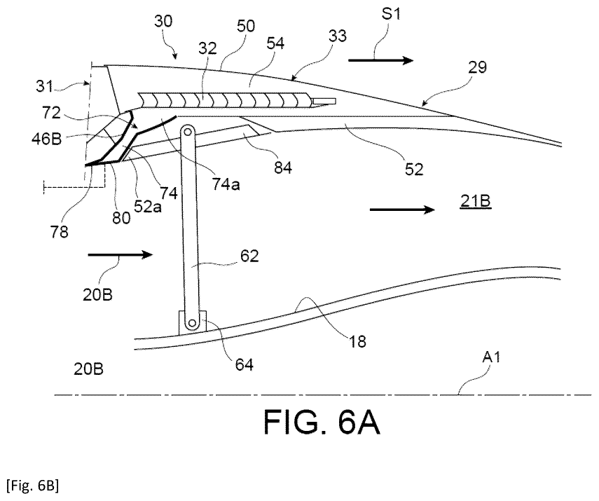

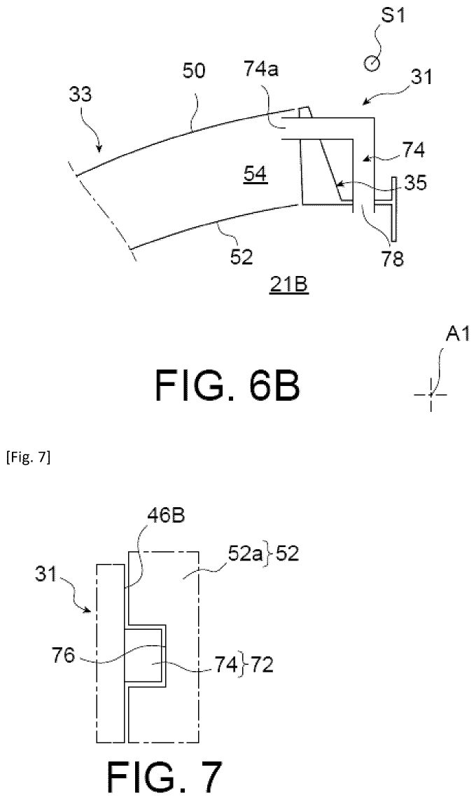

Specific means are thus provided to cause the movement towards the rear of each movable cowl 33, as will be described below with reference to FIGS. 6 to 9, corresponding to other views of the reverser according to the embodiment previously described with reference to FIGS. 1 to 5.

Indeed, the reverser comprises, for each movable cowl 33, a system 72 for moving this movable cowl towards the rear, by injecting pressurized air into the cavity 54 thereof. To this end, the system 72 is equipped with at least one duct 74 for injecting pressurized air, of which a radially outer end 74a relative to the axis A1 communicates with the cavity 54 when the movable cowl 33 is in the advanced direct thrust position of FIG. 6. More precisely, this end 74a of the duct has a flared shape, and opens into the cavity 54, under the cascades 32 near an upstream end thereof. This design only represents one particular example, and the end 74a of the duct 74 is not necessarily located radially outwards relative to the other end of this duct. For example, it may be a duct that comes from a compressor sample that leaves towards the aircraft. Indeed, deflection towards the reverser may be provided, the end 74a dedicated to supplying the cavity therefore not necessarily being radially outwards relative to the other end.

In the representation of FIG. 6, the flared end 74a is protruding inside the cavity 54. Nevertheless, according to another preferred embodiment of the invention shown in FIG. 6A, this end 74a does not penetrate or penetrates little into the cavity 54 that makes it possible to supply air. The end 74a is also shown here with a non-limiting flared shape. FIG. 6A is a preferred configuration wherein the means for closing the secondary flow path 21B are made with conventional flaps 84, which, in a direct thrust configuration, have an upstream end bearing against the end of the duct 74 bearing the scoop 78. This closing flap 84 configuration may be implemented in all preferred embodiments of the invention.

The duct 74 is integral with the stationary structure 31, preferably being supported by the deflection edge 46B, projecting downstream from this same edge 46B. Alternatively, the duct 74 may be supported and pass through other elements of the stationary structure 31. In the example shown in FIG. 6B, the duct 74 is supported by a fixed beam 35 located in the 6 o'clock position on the reverser. It passes through this beam 35 once at the level of the scoop 78 to scoop the air from the secondary flow 21B, and a second time at a circumferential end of the cowl 33 so that the end 74a thereof communicates with the inside of the cavity 54. A similar configuration is possible at the other fixed beam of the reverser (not shown) arranged in the 12 o'clock position.

This choice provides greater freedom in the axial positioning of the duct 74, and it avoids making a notch at the front end of the flaps and the inner panel 52 for the passage of the duct 74, as well as the dedicated sealing. This choice also avoids local obstruction of a portion of the channels of the cascade 32, facing the duct 74.

These two elements 46B, 74 may be made of a single piece, or the duct 74 may be attached to the deflection edge 46B by conventional means, for example by welding. The duct 74 is thus in the opening passage 56. In the advanced direct thrust position of the cowl 33, the upstream end 52a of the wall 52 of this cowl is in contact with or in close proximity axially to a downstream wall of this duct, as has been schematically shown in FIG. 7. To this end, a cut-out 76 may be provided on this upstream end 52a, for the passage of the duct 74 protruding from the trailing edge.

At the opposite end of the duct 74, that is to say that located radially inwards, the duct is connected to a means for supplying pressurized air to this duct. Here, the means corresponds to a scoop 78, located in the extension of the radially inner end of the duct 74, or forming this same end. Also flared in shape, this scoop 78 is provided to scoop a portion of the pressurized air from the secondary flow 20B. It is preferably of dynamic design, for example of the NACA type (developed by the National Advisory Committee for Aeronautics).

Furthermore, the scoop 78 is equipped with a controlled valve 80 making it possible, in the open position, for pressurized air to flow through the injection duct 72. Alternatively, the controlled valve 80 may be provided on the duct downstream of the scoop, without departing from the scope of the invention.

The valve 80 is controlled by a valve control system 82, for example the FADEC (corresponding to the acronym for “Full Authority Digital Engine Control”). The control system 82 is capable of delivering an electrical signal to the valve so as to switch it from an open position to a closed position, and vice versa.

In flight, when the reverser is in direct thrust configuration, the valve 80 is held in the closed position by the control system 82. Consequently, no sample is taken from the secondary flow 20B by the scoop 78.

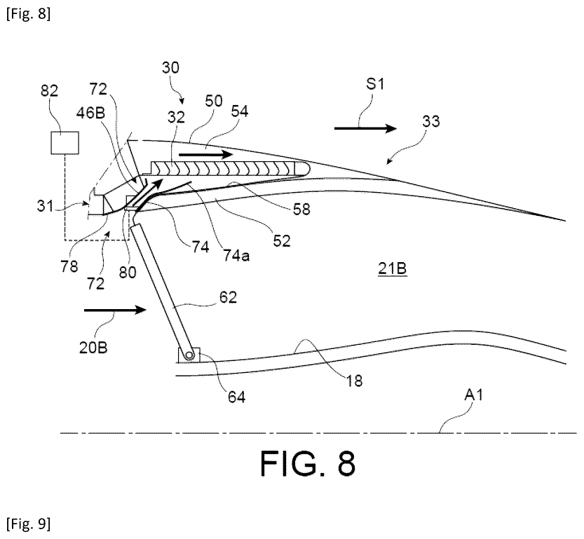

When the reverser must be switched to the thrust reversal configuration, a movement of the movable structure 31 is carried out from the advance direct thrust position thereof to the retracted thrust reversal position thereof, and to this end, not only is an unlocking of each movable cowl 33 carried out relative to the stationary structure 31 of the reverser, but also a step of controlling the valve 78. Indeed, the control system 82 opens the valve 80, so that the scoop 78 can fulfill the function thereof by scooping a portion of the secondary flow 20B, as has been schematically shown in FIG. 8. This makes it possible for the pressurized air sample to flow through the injection duct 74, and therefore to inject this air into the cavity 54. Due to the high pressure of the air on the surfaces of the walls 50, 52 of the cowl 33 inside the cavity 54, a movement of this cowl 33 towards the rear occurs in the direction of the retracted thrust reversal position thereof.

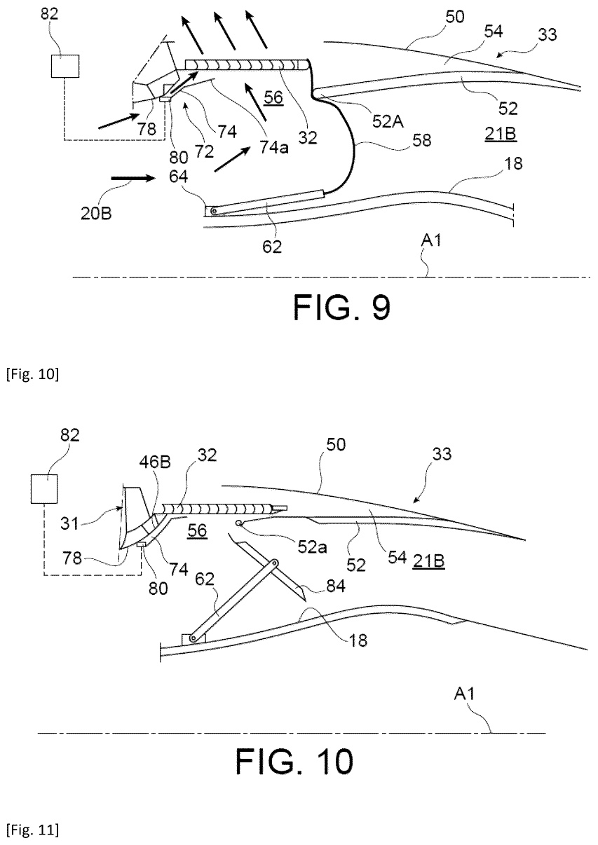

Thus, the movement system 72 specific to the invention makes it possible to simply, reliably and efficiently generate a forward thrust at the beginning of the opening travel of the movable cowl 33. The pressure of the air coming from the injection duct 74 may also contribute to moving the movable cowl during the continuation of this opening travel, even when the end of the injection duct is no longer in the cavity 54, but simply axially facing this cavity. However, after significant opening or total opening of the movable structure 33 as shown in FIG. 9, all or some of the air from the duct end 74a passes through the cascades 32, so as to contribute to the counter-pressure.

Consequently, the continuation of this opening travel of the movable cowl 33 is preferably carried out under the effect of other principles, such as dragging the air on the outer surface of the wall 50, or the negative pressure observed at the rear of the cowl 33, or introducing the pressurized air from the secondary flow path directly into the cavity by the opening caused by retracting the translating panel, or when external air enters by scooping into the opening created at the front of the translating external panel. An actuator of a conventional type, but of a small size, may nevertheless be retained to ensure this in-flight end of opening travel, even if this is not the preferred solution. The presence of such a smaller sized actuator may also be justified to perform test operations before the flight, and/or to permit ground maintenance operations with the movable structure 29 in the retracted position.

Furthermore, an actuator may be provided to ensure the closing travel of the movable structure 29, corresponding to the movement thereof from the retracted thrust reversal position, to the advanced direct thrust position.

It is noted that the number of pressurized air injection ducts 74 associated with each movable cowl 33 may be between one and six. Each duct is preferably equipped with its own control valve 80. When they are several, these ducts 74 are preferably distributed circumferentially in an even manner about the axis A1.

As mentioned previously, the duct 74 may alternatively or simultaneously be supplied by air taken from the compressor of the turbojet engine, for example by a branch on the tubes of the anti-icing system of the nacelle that routes pressurized air from the compressor to the air inlet lip of the nacelle, passing close to the fixed parts of the reverser in the bifurcations.

According to yet another alternative, the air may come from a sampling of the outside air at the outer surface of a fan cowling. A duct supplied by this controlled sampling of outside air, and passing through the front frame of a fixed cascade reverser, may then bring the outside air into the cavity.

FIG. 10 shows another preferred embodiment of the invention, wherein the means for closing the secondary flow path 21B are made using flaps 84. In this respect, it is noted that these conventional closing means, of the flap type 84, may be preferred over the membrane solution described relative to the preceding figures. Moreover, all the characteristics specific to the various preferred embodiments of the invention may be implemented with closing flaps 84.

The flaps 84 are for example each articulated at one of the ends thereof on the upstream end 52a of the wall 52, and also articulated in a central area on a connecting rod 64, itself articulated on the wall 18. In this configuration, these are conventional, non-scooping closing flaps 84.

It is noted that a mixed solution integrating both closing flaps and membranes for closing the flow path remains possible, without departing from the scope of the invention.

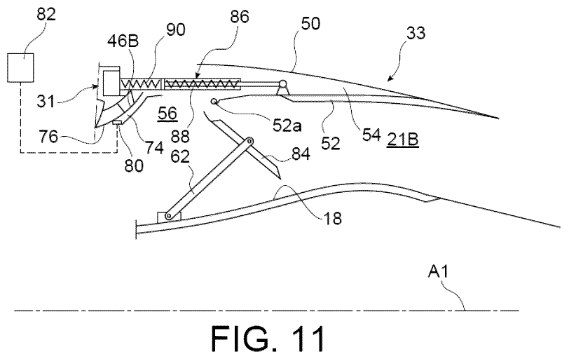

Finally, FIG. 11 shows an alternative to this last preferred embodiment, but which may be applied to the first embodiment described previously.

Between the stationary structure 31 and the movable structure 29, a damping device 86 is provided for the end of opening travel of the movable cowl 33, for example in the form of a mechanical cylinder equipped with one or more damping springs 88. Within this device 86, or in a separate device, mechanical means for thrusting forward the opening travel of the movable cowl 33 may also be provided, preferably also in the form of elastic means such as one or more drive springs 90. For example, the device 86 may be implanted circumferentially between the deflection cascades, and one or more of them equip each of the two movable cowls 33. These damping means may be incorporated into additional opening or closing cylinders or ball screws. Preferably, the reverser includes means for taking up the counter-thrust forces between the movable structure and the stationary structure generated on the means for closing the flow path and the movable structure. These means may be shared with the damping device and/or the additional opening and closing cylinders, or may be separate means such as stops at the slide rails or dedicated telescopic rods.

Various modifications may be made by the person skilled in the art to the invention just described, only by way of non-limiting examples, and the scope of which is defined by the appended claims. For example, the thrust reverser 30 may alternatively have a “C-Duct” or “O-Duct” architecture. Furthermore, if the preferred embodiments described above relate to a design of a reverser with fixed deflection cascades, these cascades may alternatively be integrated into the movable structure of the reverser.

What is claimed is:

1. A thrust reverser for an aircraft propulsion unit, the reverser comprising a stationary structure equipped with a radially inner delimiting wall of a secondary duct of the propulsion unit intended to be passed through by a secondary flow, the reverser also comprising a movable structure comprising at least one movable reverser cowl having a cavity delimited between a radially outer wall and a radially inner wall of the movable reverser cowl, the movable structure being translatable relative to the stationary structure along a longitudinal central axis of the reverser, between an advanced direct thrust position and a retracted thrust reversal position, wherein the reverser also comprises a system for moving the movable cowl to the retracted thrust reversal position, by injecting pressurized air into said cavity, the movement system including:
at least one duct for injecting pressurized air, one end of which communicates with said cavity when the movable cowl is in the advanced direct thrust position, the injection duct being integral with the stationary structure of the reverser;
a means for supplying pressurized air to the injection duct;
a controlled valve making it possible, in the open position, for pressurized air to flow through the injection duct.

2. The thrust reverser according to claim 1, wherein the stationary structure includes a deflection edge against which the radially inner wall of the movable reverser cowl is bearing, when it occupies the advanced direct thrust position thereof, and in that the pressurized air injection duct is supported by the deflection edge, preferably at the rear of the latter.

3. The thrust reverser according to claim 1, wherein the means for supplying pressurized air to the injection duct includes at least one scoop, designed to scoop pressurized air from the secondary flow into the secondary flow path.

4. The thrust reverser according to claim 1, wherein the number of ducts for injecting pressurized air within the system for moving the cowl is between one and six, distributed circumferentially about the longitudinal central axis.

5. The thrust reverser according to claim 1, wherein in the retracted thrust reversal position of the movable structure, the stationary structure of the reverser and an upstream end of the radially retracted inner wall of the movable reverser cowl reveal between them an opening for air to pass through the secondary flow path, the thrust reverser also comprising means, for closing the secondary flow path, designed to deflect at least one portion of the secondary flow towards the passage opening.

6. The thrust reverser according to claim 5, wherein the closing means comprise at least one closing flap and/or at least one closing membrane.

7. The thrust reverser according to claim 1, wherein the stationary structure of the reverser includes at least one deflection cascade arranged, in the advanced direct thrust position of the movable structure, in the cavity of the movable cowl, by being isolated from the secondary flow path by the radially inner wall of the reverser cowl.

8. The thrust reverser according to claim 1, further comprising a device for damping the end of opening travel of the movable cowl, in the movement thereof from the advanced direct thrust position to the retracted thrust reversal position.

9. An Aircraft propulsion unit, comprising a turbine engine and a nacelle including at least one fan cowling, as well as the thrust reverser according to claim 1.

10. A method for controlling the thrust reverser according to claim 1, wherein to drive the movement of the movable structure from the advanced direct thrust position thereof towards the retracted thrust reversal position thereof, the method comprises a step of unlocking the movable cowl relative to the stationary structure of the reverser, as well as a step of controlling the valve of the movement system so as to bring it into the open position, making it possible for pressurized air to flow through the injection duct and to inject this pressurized air into the cavity of the movable cowl, in order to cause it to move to the retracted thrust reversal position.
